(19) United States
(12) Patent Application Publication
(10) Pub. No.: US 2017/0024814 A1
(43) Pub. Date: Jan. 26, 2017

(54) COMPUTER SYSTEM AND METHOD FOR FACILITATING A MORTGAGE ASSET EXCHANGE

(71) Applicants: Thomas D. CASEY, Bethesda, MD (US); Craig C. HESS, Old Greenwich, CT (US)

(72) Inventors: Thomas D. CASEY, Bethesda, MD (US); Craig C. HESS, Old Greenwich, CT (US)

(21) Appl. No.: 15/049,191

(22) Filed: Feb. 22, 2016

Related U.S. Application Data
(63) Continuation of application No. 12/406,193, filed on Mar. 18, 2009, now abandoned.
(60) Provisional application No. 61/069,827, filed on Mar. 18, 2008.

(51) Int. Cl. G06Q 40/04; G06Q 40/02

(52) U.S. Cl. CPC G06Q 40/04; G06Q 40/02

(57) ABSTRACT

Computer systems and methods for providing a mortgage exchange with attributes of the NYSE, NASDAQ, CBOT, CME, NYMEX and other derivatives exchanges are disclosed. In one aspect, the resulting marketplace supports standardization, centralizes liquidity and provides price visibility of such assets. Further, the resulting marketplace provides the following benefits: being a lower-cost alternative to proprietary conduits; electronically linking separate pools of liquidity; enhancing transparency for buyers and investors; allowing the market to better price individual mortgage assets; and supporting technology advancements to better and more efficiently manage risks of investing in individual mortgages.

### CROSS REFERENCE TO RELATED APPLICATIONS

This application claims the benefit of and priority to U.S. Provisional Application Ser. No. 61/069,827, filed Mar. 18, 2008, entitled “System. Method and Computer Program Product for Facilitating a Mortgage Asset Exchange.”

This application is also related to Applicants' co-pending U.S. patent application Ser. No. 11/853,554 titled “Systems and Methods for Transacting in Association with the Federal Home Loan Banks.” filed on Sep. 11, 2007, which claims priority to U.S. Provisional Application No. 60/825,684 filed on Sep. 14, 2006.

Each of the above-referenced applications are hereby incorporated by reference in their entirety.

### BACKGROUND OF THE INVENTION

Field of the Invention

The present invention generally relates to financial exchanges such as stock, derivative, commodity and futures exchanges, and more particularly to systems, methods and computer program products for facilitating the establishment and operations of a mortgage asset exchange.

Related Art

In today's financial and technological environment, many financial instruments and commodities are traded on global exchanges throughout the world. Examples of traded financial instruments and commodities include U.S. real estate price indexes, weather futures, wheat, cheddar cheese, lumber, wood pulp, sugar, gold, stocks, options, corporate and government bonds, derivatives, crude oil, natural gas and pork bellies. Through a mixture of technology and standardizations of characteristics and quality, exchanges have created a marketplace where these seemingly intricate products can trade daily in liquid, transparent, smooth-functioning and self-regulating markets.

Some of the most known exchanges include: the New York Stock Exchange (NYSE), which lists the stocks of over 2500 public companies utilizing trading floors; the National Association of Securities Dealers Automated Quotations (NASDAQ), which is an electronic exchange that lists the stocks of over 3200 public companies: the Chicago Board of Trade (CBOT), which trades about 50 different options and futures contracts by over 3,600 members through open outcry and electronic trading: the Chicago Mercantile Exchange (CME), which trades financial instruments such as interest rates, equities, currencies, commodities and weather and real estate derivatives; and the New York Mercantile Exchange (NYMEX), which trades energy products, metals and other commodities on a trading floor and via overnight electronic trading computer systems.

There also exists a (secondary) financial market for another financial instrument—mortgages (i.e., debt obligations typically taken on by consumers to finance the purchase of real estate). That is, a secondary mortgage market with respect to residential mortgages exists where such loans are bought and sold by financial institutions either to be held in a portfolio or packaged into securities or bonds collateralized by the mortgage loans. Mortgage lenders, commercial banks and specialized firms will typically group together many mortgages (i.e., loans) and sell grouped loans as securities called mortgage-backed securities (MBS). The risk of the individual loans is thereby distributed (and for some investors, reduced) by the aggregation process.

U.S. residential mortgage markets have made great leaps in technology, consumer choice and affordability, and investor sophistication during the past twenty years. Yet, mortgage secondary markets do not yet fully operate like the above-mentioned financial instrument and commodity markets for other complex (yet, liquid) assets. Further, the mortgage secondary markets do not offer sophistication, transparency, open pricing, and liquidity equal to markets for other complex financial instruments and commodities created by exchanges such as NYSE, NYMEX and the like.

Given the lack of an exchange offering sophistication, transparency, open pricing, and liquidity in the secondary mortgage market, one class of market participants has especially suffered—community banks, thrifts and credit unions that are members of The Federal Home Loan Banks (FHLBs).

The FHLBs are 12 regional cooperatives owned by “members.” Such members include commercial banks, thrifts, credit unions, and insurance companies. FHLBs are “government sponsored enterprises” (or GSEs), meaning they are privately owned, federally chartered, and endowed with advantages such as exemption from some taxes and securities laws to facilitate a public mission. (Fannie Mac and Freddie Mac are also GSEs.) The Federal Housing Finance Board, an independent agency within the executive branch of the U.S. federal government, is charged with regulating the safety, soundness and mission of the FHLBs.

The over 8.100 members of the 12 FHLBs include thousands of community banks along with major mortgage investors, global banks and Wall Street firms such as AIG, Citigroup, Bank of America, GMAC Bank, Greenwich Capital RBS, ING, JPMorgan Chase, Lehman Brothers, Met Life, Morgan Stanley, Wachovia, and Wells Fargo.

The primary business of the FHLBs is lending to members against collateral consisting largely of mortgages. Currently, many of the FHLBs also buy fixed-rate, conforming mortgages from members and hold them in their respective portfolios. Conforming mortgages are residential loans up to a certain threshold amount that are eligible for purchase by Fannie Mac and Freddie Mac. The “conforming” threshold amount is set annually under a formula prescribed by law using data compiled by the Federal Housing Finance Board.

FHLBs are authorized only to invest in high-quality financial instruments. Thus, under Federal Housing Finance Board regulations, members of FHLBs selling mortgages to the cooperative must retain the risk of borrower default, thus raising the purchased mortgages to an imputed level of AA on the Standard & Poor's scale.

Two different mortgage programs are used by FHLBs to purchase mortgages.

One program—the Mortgage Partnership Finance® (MPF) program—was developed, and is operated, by the Chicago FHLB on behalf of themselves and other FHLBs. The MPF program utilizes proprietary software (disclosed in U.S. Pat. No. 5,966,700 which is hereby incorporated by reference in its entirety) to determine the level of credit risk managed by members to bring mortgages to the Standard & Poor's AA level. Under the MPF program, the Chicago FHLB determines the price offered, serves as master servicer and master custodian for the mortgages purchased, and performs post-purchase quality control. Participating FHLBs market the MPF program, approve members to originate loans for the MPF program using Page standards set by the Chicago FHLB, and purchase mortgages for their own investment portfolios. The MPF program participants are the Chicago, Boston, New York, Pittsburgh, Atlanta, Des Moines, Topeka, Dallas and San Francisco FHLBs.

The other program—the Mortgage Partnership Program (or MPP)—is currently utilized by the several other FHLBs. The MPP utilizes proprietary software to operate independent mortgage purchase programs. Under the MPP, participating FHLBs determine their own prices, approve members to originate loans, act as master servicer and master custodian, and set eligible product policies within the subset of fixed-rate conforming loans, purchase for their own portfolios and manage post-purchase quality control. The MPP participants are currently the Seattle, Indianapolis, Cincinnati and Atlanta FHLBs.

Both programs consist of three sets of basic business functions. The first set of functions is marketing the program to members, qualifying them to participate, and facilitating the sale/purchase transactions (including payment). The second set is pricing loans for purchase and managing an investment portfolio of fixed-rate, long-term mortgages. The third set of functions consists of maintaining information on the financial and legal characteristics of each mortgage in the portfolio and overseeing the loan servicing and document custody, and post-purchase quality control.

Further, in today's mortgage secondary market, it is cost prohibitive for large proprietary conduits to establish relationships and transaction infrastructure with more than a relative handful of community banks, thrifts and credit unions. Smaller institutions are unable to provide enough volume to justify the expense of recruiting such community banks, thrifts and credit unions to these conduits.

The residential mortgage secondary market is, in large part, designed to meet the needs of Fannie Mae, Freddie Mac and the major MBS issuers to purchase mortgages in large quantities. Large volume delivery mechanisms of today are not always able to nimbly react to volume ebb and flow, or to access originations available from community banks.

To help control quality and meet the need for large volume mortgage deliveries, many major MBS issuers have purchased mortgage banks. Others have developed correspondent lender networks and warehouse financing arrangements with mortgage banks. While these conduits worked well, some recently led to large write-downs of fixed costs due to the subprime collapse. Many correspondent and warehouse channels have been closed or curtailed. Along with temporarily reduced volumes, the market, investor and MBS issuer priorities are shifting permanently.

Given the foregoing, what are needed are systems, methods and computer program products for facilitating the establishment and operations of a mortgage asset exchange.

### BRIEF DESCRIPTION OF THE INVENTION

Aspects of the present invention meet the above-identified needs by providing systems, methods and computer program products for facilitating the establishment and operations of a mortgage asset exchange (“MAX”).

Aspects of the present invention provide a mortgage exchange with attributes of the NYSE, NASDAQ, CBOT, CME, NYMEX and other derivatives exchanges. The resulting marketplace supports standardization, centralizes liquidity and provides price visibility. The resulting marketplace would also provide the following benefits: being a lower-cost alternative to proprietary conduits; electronically link separate pools of liquidity; enhance transparency for buyers and investors; allow the market to better price individual mortgage assets; and support technology advancements to better and more efficiently manage risks of investing in individual mortgages.

An advantage of aspects of the present invention is that it brings together the advantages of electronic exchanges with unique attributes of the Federal Home Loan Bank (FHLB) System to make mortgage secondary markets more transparent, more liquid, more stable and more cost efficient.

An advantage of some aspects of the present invention is that existing FHLB software can be linked with MAX to transmit approximately 80 or more fields of loan-by-loan data, allowing for superior transparency into the credit profile of borrowers, the real estate securing mortgages, and the terms for mortgages sold or purchased on the MAX.

Another advantage of some aspects of the present invention is that it offers league-leading transparency, allowing sellers to reap a premium for prudent underwriting and to follow market trends to focus origination efforts on products in demand in secondary markets or niches without adequate supply.

Another advantage of some aspects of the present invention is that buyers are empowered by transparency. That is, buyers can deploy software tools to sort through hundreds of individual mortgages to identify specific factors. MAX data allows sophisticated pricing decisions and assembly of pools with specific diversity and credit characteristics.

Another advantage of some aspects of the present invention is that large purchasers can customize their use of MAX through an Application Programming Interface (API). APIs enable users to run proprietary algorithms to sort hundreds or thousands of mortgages posted on MAX to automatically assemble customized pools.

Another advantage of some aspects of the present invention is that unparalleled loan-by-loan data is made available thereby endowing MBS issuers trading on MAX with an advantage in non-agency MBS markets by sharing transparency with investors.

Yet another advantage of aspects of the present invention is that buyers are equipped to make more sophisticated pricing decisions and can leverage automation and transparency to assemble pools with specific diversity and credit characteristics.

Yet another advantage of aspects of the present invention is that it employs automation and standardization to aggregate relatively small volumes of high-quality originations for delivery to investors and securitizers seeking large volumes.

Yet another advantage of aspects of the present invention is that it—like other liquid, transparent and smooth-functioning exchanges—generates competitive pricing and rewards quality and reliability. With modest expense and minimized counterparty risk, large MBS issuers and investors in whole loans can assemble bulk purchases of specified loan types from multiple, diverse originators.

Yet another advantage of aspects of the present invention is that by emphasizing low, transaction-based costs, reliable and sound credit decisions, a nimble product mix with adaptable trading options, and the strength of the FHLB system, it allows buyers and sellers to continually adapt to the needs of borrowers and the preferences of investors.

Yet another advantage of aspects of the present invention is that it makes markets more competitive, transparent and responsive to investors—who will be better informed through MAX transaction data—and thus result in increased and stabilized liquidity.

Yet another advantage of aspects of the present invention is that it provides holders of whole loans—whether originators, investors or securities issuers—a tool to quickly and efficiently ascertain market prices or liquidate positions, thus also enhancing liquidity. Instead of“sending a tape” to one or a few potential buyers, detailed portfolio information can be exposed to numerous, differently-motivated bidders simultaneously.

Yet another advantage of aspects of the present invention is that it can help community banks capture and retain mortgage market share during a period characterized by the closing of many mortgage banks and brokers, correspondent conduits and wholesale mortgage operations.

Yet another advantage of aspects of the present invention is that it equips mortgage buyers with superior information and cost control. That is. MAX provides direct access to thousands of FHLB members not fully served by existing secondary market channels.

Yet another advantage of aspects of the present invention is that, beyond serving as a “virtual conduit” for MBS issuance platforms, it allows investment banks to offer clients seeking to invest in whole loans (e.g., insurance companies and hedge funds) the benefits of trading through MAX to acquire sound loans of specified type and quality from lenders making credit decisions as part of banking relationships.

Further features and advantages of aspects of the present invention, as well as the structure and operation of these various aspects of the present invention, are described in detail below with reference to the accompanying drawings.

### BRIEF DESCRIPTION OF THE DRAWINGS

The features and advantages of aspects of the present invention will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is a system diagram of an exemplary environment in which the present invention, in an aspect, would be implemented.

FIG. 2 is a flowchart illustrating a trading flow according to one aspect of the present invention.

FIG. 3 is a block diagram of an exemplary computer system useful for implementing the present invention.

### DETAILED DESCRIPTION

Aspects of the present invention are directed to systems, methods, and computer program products for facilitating the establishment and operations of a mortgage asset exchange (“MAX”).

In one aspect of the present invention, a mortgage asset exchange (“MAX”) meets the demand to make mortgage secondary markets more cost efficient, transparent, liquid and stable by combining electronic exchange technology with unique attributes of the Federal Home Loan Bank System to enhance mortgage secondary markets.

In such an aspect, bids and offers are posted and transactions cleared on a secure computer network connecting thousands of financial institutions which are part of the FHLB system. Such institutions would have access to MAX, and the operator of the MAX and/or Introducing Members would assure trades clear as agreed and facilitate resolution of errors or problems, including overseeing “put backs.”

In such an aspect, the FHLBs and other highly-rated financial firms are eligible to be “Introducing Members”—similar to NYSE seat holders. The MAX provides:
High-quality underwriting by well-capitalized and regulated originators;
Enhanced transparency for mortgage purchasers and MBS investors;
New tools to control quality and diversity of mortgage investment portfolios or mortgage securitization pools;
A unique service for asset management clients investing in whole loans—customization of portfolios to meet specified criteria for diversity, risk, etc.;
A virtual conduit offering buyers a low-cost alternative to warehouse and correspondent channels;
Improved market access for small volume, high quality lenders through automated aggregation of standardized loan types;
An alternative to existing correspondent and warehouse arrangements for community banks, thus rewarding sound underwriting without penalizing low volume; and
A superior tool for sourcing loans to hold in the portfolios of community banks buying mortgages.

The present invention is now described in more detail herein in terms of the above exemplary FHLB context. This is for convenience only and is not intended to limit the application of the present invention. In fact, after reading the following description, it will be apparent to one skilled in the relevant art(s) how to implement the following invention in alternative aspects (e.g., non-FHLB contexts, loans other than mortgages, etc.).

The terms “user”, “member”, “institution”, “buyer”, “seller”, “participant”, “investor”, “securitizer”, and/or the plural form of these terms are sometimes used interchangeably throughout herein to refer to those persons or entities capable of accessing, using, be affected by and/or benefiting from the electronic exchange tool that the present invention provides for trading mortgage assets.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

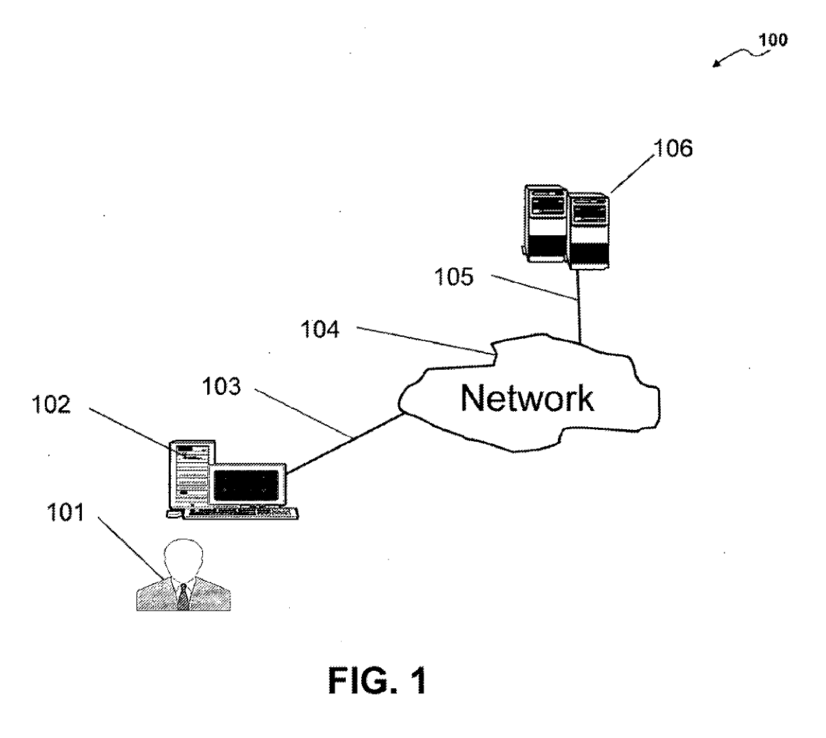

Referring to FIG. 1, a (simplified) system diagram of an exemplary MAX trading system 100 in which the present invention, in an aspect, would be implemented is shown.

FIG. 1 presents an exemplary system diagram 100 of various hardware components and other features in accordance with an aspect of the present invention. As shown in FIG. 1, in an aspect of the present invention, data and other information and services for use in the system are, for example, input by a user (i.e., member, trader, FHLB personnel, market participant and/or the like) 101 via a terminal 102, such as a personal computer (PC), minicomputer, laptop, palmtop, mainframe computer, microcomputer, telephone device, mobile device, personal digital assistant (PDA), or other device having a processor and input, display and communications capabilities. Terminal 102 is coupled to a server 106, such as a PC, minicomputer, mainframe computer, microcomputer, server computer, or other device having a processor and one or more associated repositories for data or connection to one or more repositories for maintaining data, via a network 104, such as the global, public Internet, via (wired and/or wireless) communications couplings 103 and 105.

As will be appreciated by those skilled in the relevant an(s) after reading the description herein, in such an aspect, a service provider (i.e., an exchange operator) may allow access, on a free registration, paid subscriber/membership, and/or pay-per-use basis, to the tool the present invention provides for facilitating mortgage asset exchanging (i.e., trading) via one or more World-Wide Web (WWW) sites on the Internet 104. Thus, system 100 is scaleable such that multiple market participants may utilize it to allow their traders to buy, sell and generally interact with other users of system 100.

As will also be appreciated by those skilled in the relevant art(s), in an aspect, various screens (e.g., login, admin, account information, resources, upload, search, logout, payment, registration, communications, etc.) would be generated by server 106 in response to input from users 101 over the Internet 104. That is, in such an aspect, server 106 is a typical Web server running a server application at a Web site which sends out Web pages in response to Hypertext Transfer Protocol (HTTP) or Hypertext Transfer Protocol Secured (HTTPS) requests from remote browsers being used by users 101. Thus, server 106 is able to provide a graphical user interface (GUI) to users 101 of system 100 in the form of Web pages. These Web pages are sent to the user's PC, laptop, mobile device, PDA or the like device 102, and result in the GUI screens being displayed.

As will also be appreciated by those skilled in the relevant art(s) after reading the description herein, alternate aspects of the present invention may include providing the tool for facilitating mortgage asset exchanging (i.e., trading) as an enterprise system wherein all the components of system 100 are connected and communicate via an intra-corporate wide area network (WAN) or local area network (LAN), rather than as a Web service (i.e., application service provider (ASP) model) as shown in FIG. 1.

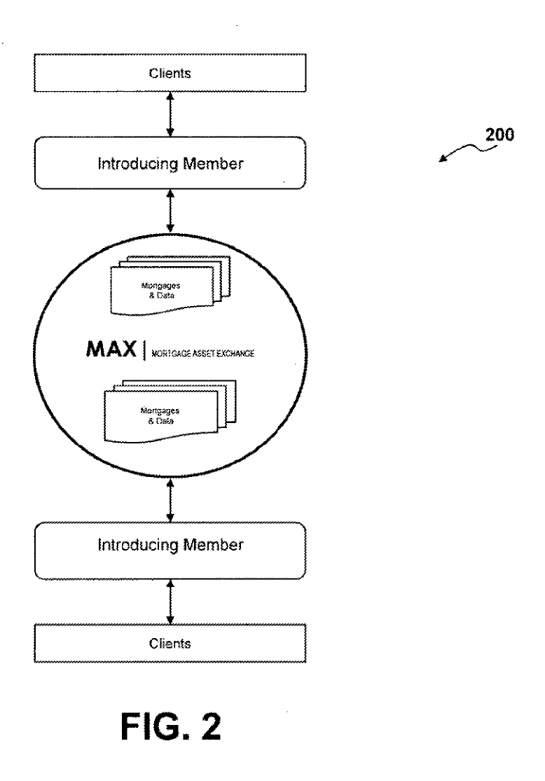

Referring now to FIG. 2, a flowchart illustrating a trading flow 200 according to one aspect of the present invention is shown. In such an aspect of the present invention, MAX system 100 is provided as an electronic exchange (without a physical trading floor), where the members of the FHLB system can confidently buy and sell mortgages, clear trades and transfer funds electronically with low operational cost and counterparty risk. Sellers may post inventory and buyers offer bids through a private, secure computer network (or a secure Internet connection). Once a deal is made, trades are cleared through MAX and the transfer of mortgages (and their associated documents) will be facilitated by the MAX information system.

In an aspect of the present invention, MAX ensures orderly market operations through “Introducing Members,” which include the Federal Home Loan Banks and other highly-rated financial institutions. Introducing Members may trade on their own behalf and/or provide access to MAX for their respective clients. The FHLBs also fill key clearing and settlement roles in transferring funds between buyers and sellers and overseeing resolution of trading errors and problems including “put backs” of early defaulting or non-compliant loans.

In such an aspect of the present invention, limiting MAX participants to FHLB System members ensures that counterparties in every transaction are strong, reliable and perform as agreed and expected before, during, and after a trade clears. This limits risk and provides efficiency which allows MAX to link community banks throughout the United States with not only Wall Street, but with the global markets.

In an aspect, a single MAX transaction can purchase and clear hundreds of mortgages from different originators without the expense and complexity of establishing relationships with hundreds of community banks. Payments flow between Introducing Members for credit or debit to customer accounts. Standards and settlement assurance are overseen by FHLBs, enabling buyers to confidently accept mortgages from any MAX seller.

Likewise, a seller can use MAX to offer mortgages to many buyers without the expense and risk of establishing relationships and accounts with each individual buyer. Through automation, buyers can purchase large volumes of mortgages while MAX technology handles aggregation and clearing of standardized, high quality loans available from well-capitalized, insured and regulated community banks.

In an aspect of the present invention, a transaction on the MAX would occur as follows:
A. A seller (e.g., a FHLB, a member of an FHLB or other market participant given access to the MAX by an Introducing Member) would enter data points relating to the property, lender and borrower associated with one or more mortgage loans they wish to sell using the MAX (e.g., lender's name, FHLB district, city, state, zip code, county, number of bedrooms, borrower's income, borrower's FICO score, loan-to-value ratio, etc.). In one aspect, this data may be entered by a user 101 using a terminal 102 for eventual uploading onto server 106 and its associated data stores. In another aspect, this data may be “pushed” from a FHLB member's proprietary computer systems directly onto server 106 and its associated data stores via a secure communications link.
B. The seller would then enter an ask price for each mortgage posted to the Max system in Step A above. In one aspect, this may be done manually for each mortgage. In another aspect, this may be done using a pre-determined formula based on the approximately 80 different data points relating to the property, lender and borrower associated with a single mortgage loan as will be appreciated by those skilled in the relevant art(s) after reading the description herein. In yet another aspect, the ask price may fluctuate over time based upon one or more (external or internal) market conditions as dictated by the seller.
C. A buyer (e.g., a FHLB, a member of the same FHLB as the seller, a member of a different FHLB than the seller or any other market participant given access to the MAX by an Introducing Member) may then use their own terminal 102 to access server 106 and its associated data stores to search for one or more mortgages they desire to buy. Such a search, in one aspect, may be based on the approximately 80 different data points relating to each mortgage loan.
D. Upon the buyer selecting one or more they desire to purchase, the corresponding seller(s) would receive a notification from the MAX system that their mortgage loan(s) posted in Step A above have been sold according to one or more predetermined standardized contracts.
E. Based on the standardized contract selected for the sale, a settlement date is indicated by the MAX system for closing of the transaction. On the settlement date (e.g., 3-5 days from the purchase date), in one aspect, the purchase price is transferred from the buyer's account at their associated FHLB to the seller's account at their associated FHLB.
F. Next, in one aspect, the buyer would have to settle their account with their associated FHLB. As will be appreciated by those skilled in the relevant art(s), the FHLB associated with the buyer may require funds in the buyer's account prior to the buyer purchasing the loan(s) on the MAX, or the buyer may operate under a financial arrangement with the FHLB under which the FHLB would act as a guarantor of the buyer's MAX transactions.

In one aspect of the present invention, trading on the MAX would be limited to FHLB members. That is, FHLBs will have the option of being Introducing Members, marketing the MAX to their respective members and providing access to the exchange to their respective members. In such an aspect of the present invention:

FHLBs would manage the settlement risk for each transaction. This means a FHLB would maintain a financial instrument or vehicle that can be drawn upon to provide alternative satisfaction to a buyer whose seller failed to perform, or to a seller whose buyer failed to perform. A financial instrument posted with the MAX by the FHLB on behalf of the member would accomplish such alternate satisfaction. As will be appreciated by those skilled in the relevant arts(s) after reading the description herein, the strength of FHLBs as GSEs makes this a powerful attribute of the MAX.

Each FHLB member must purchase stock in its cooperatively-owned FHLB. If the member borrows from the FHLB, as most regularly do, it also posts collateral (typically in the form of mortgages or highly-rated securities) with the FHLB. By law, each FHLB also has a “super lien” on the assets of a member eligible to serve as collateral. The “super lien” means the FHLB stands “first in line” in case the member institution defaults, even before the FDIC. This collateral power and the member's FHLB stock will stand behind the instrument used by the FHLB to manage settlement risk. In the event of trading errors or other problems, the FHLBs may also assist in resolving the error or problem.

In the event an early-defaulting mortgage or mortgage not complying with the contract under which it was traded is “put back” to the seller, the seller's FHLB will manage the risk that this action not proceed as provided by the MAX exchange rules or a trading contract. Like the management of settlement risk, this too may be handled in various ways. One method is a “forced advance” or loan imposed by the FHLB on the member in the amount due to the buyer expecting the “put back” to be repurchased. In most cases, however, the “moral authority” inherent in the FHLB's position as a critical provider of liquidity to the member and the power of the FHLB as a cooperative should suffice to ensure performance. Another key attribute of this method for handling “put backs” is that FHLB members, unlike mortgage brokers and mortgage banks, rarely lack adequate capital to fulfill “put back” obligations in times of extreme market stress. The fees charged and terms of settlement risk and “put back” risk management will be independently negotiated by each participant and its FHLB.

FHLBs may also handle fund transfers among buyers and sellers. Instead of maintaining accounts for many potential buyers and sellers, each participant can utilize their existing FHLB accounts (as FHLB members) to receive payments or make payments for MAX trades. Here too, the strength of FHLBs, existing relationships, and cooperative nature provide participants confidence in dealing with counterparties they may not know.

In alternate aspects, as will be appreciated by those skilled in the relevant art(s), the above-described flow may vary such that the MAX may be utilized (and navigated) in ways other than presented above. For example: sellers may respond to buyers who post onto the MAX the desire to purchase specific mortgage loans; buyers may be able to suggest a bid price different than the ask price and thus create a spread; a FHLB may charge a fee for the financial instrument; the operator of the MAX may charge bulk usage, membership and/or per transaction fees; FHLBs may need to periodically settle accounts amongst themselves for transactions occurring on the MAX; etc.

In one or more aspects of the present invention, as will be appreciated by those skilled in the relevant art(s), the MAX may support the following types of transactions:
Simple Sell: This is a transaction where, for example, a bank has a certain amount of specific mortgages to sell. They would simply use a GUI provided by system 100 to input information about the loans, or connect via their existing desktop underwriting system, and the mortgages would be posted individually on the MAX, with the necessary data to appropriately price them. In such a transaction, each mortgage would have a static sales price.
Simple Buy: This is a transaction where a buyer can search through mortgages posted on the MAX, or use discovery software sorting and selecting orders that fit a certain set of criteria. Then, the buyer can simply buy one or more of the individual mortgages at the listed price, or bid at a lower price and wait for the mortgage price to lower to their bid price.
Linked Price Orders: This is a transaction where, instead of static pricing, a seller or buyer may choose to link their offer price to some other financial instrument that changes dynamically. For example, a bank may want to sell/buy their mortgages for a certain amount below/above the 10-year US Treasury Note. This will cause their offer price to change with the Treasury Note's price. The buyer/seller may also link their orders to their cost of capital, FHLB advance rate, LIBOR, or any other rate or index for which the MAX receives real-time pricing.
Linked Mortgages: In this type of transaction, a seller desires to sell a pool of mortgages together. When mortgages are linked, any individual mortgage can only be sold when buyers for every mortgage in the pool are identified. Some buyers may want to assemble a pool and only buy the pool if they could get a certain “face value.” For example, a buyer may want to create a $10M pool, but does not want to purchase unless they can buy all $10M at once. Thus, a linked buy order would only execute on the MAX if the full $10M could be purchased.
Program Trades: In this type of transaction, buyers will use (off-the-shelf or proprietary) computer application programs to assemble a pool with specific characteristics or factors. For example, a buyer may execute an application that searches through the mortgages posted on the MAX, and then buy specific mortgages in certain zip-codes with high Loan-to-Value and high income, or, low Loan-to-Value with low credit scores, but in a way that maintains one or more certain overall portfolio criteria. In sum, these program trades combine a set of pricing criteria to purchase a specific kind of pool.

Blind Orders and Dark Markets: Other order types that are supported by the MAX are called “blind” and “dark” orders, which refer to those orders which are not visible as offers to buy or sell. Institutions may use these order types to list large blocks of mortgages without alerting the marketplace as a whole of the sale or purchase. There are many types of blind orders and methods for working within “dark” markets:
Blind Orders: In this type of transaction, a financial institution will enter orders to buy or sell on the MAX, but some portion (or all) of the orders will not be visible on the exchange. Such orders become visible, however, when a buyer executes an order to buy a mortgage, or when a program trade is occurring. For example, if a seller wants to sell 100 mortgages of a similar price and type, they could only show five as being available, but have all 100 available for purchase when a buyer executes an order for one or more of the five visible mortgages. Sometimes, the seller may choose to not show any visible orders.
Dark trading: the MAX may employ one or more algorithms that understand each member's recent behaviors and characteristics for the purpose of helping buyers and sellers identify liquidity that might not be visible because either side of the order has not been entered yet. For example, a large buyer may have recently purchased mortgages with a certain set of criteria every day for the last week, but they are not currently bidding. If a large seller is offering mortgages with the same criteria as those historic orders, the MAX (via a GUI alert) will suggest a private transaction alerting the two parties that they have a potential trade.

In alternate aspects of the present invention, members of the FHLB System can route orders to MAX using front-end, software developed for current FHLB mortgage purchase programs (e.g., the MPF program and MPP). Capitalizing on this IT asset enables MAX to connect to originators trained and experienced in using the software and transmitting mortgage data electronically. In other aspects of the present invention, other desktop origination and conduit platforms may be supported.

In an aspect of the present invention, the MAX technology platform allows sophisticated trading algorithms, enabling large-volume buyers to cost effectively tap the high quality mortgage underwriting of community banks throughout the U.S. to assemble an investment portfolio or securitization pool with specific quantitative characteristics. Purchasing decisions can then be tailored in sophisticated ways to meet MBS or whole loan investor priorities.

In aspects of the present invention, as will be appreciated by those skilled in the relevant art(s) after reading the description herein, the types of mortgages capable of being traded on MAX include: jumbo, conforming fixed rate or adjustable rate, Alt. A, FHA/VA, HELOCs, reverse mortgages, standardized underwriting criteria, non-standardized mortgages, and affiliate originations. In such aspects, MAX trading options include: single loans, pools (of any size), flow delivery, closed loans or pools, future delivery commitments, and anonymous posting of pools for price discovery. In alternate aspects, servicing-released and servicing-retained options may also be supported on MAX.

In aspects of the present invention, there are numerous ways MAX is useful to buyers and sellers of mortgages:

MAX lowers the cost of sourcing mortgages for investors and securitizers. As a shared platform, expenses are spread across all users. Instead of the fixed overhead costs of a proprietary conduit, MAX fees may be assessed on each transaction or overall usage. Funding costs during the aggregation period can be managed by allowing loans to remain on the balance sheets of originators while a pool is assembled. In other words, MAX is “just in time inventory management” for MBS issuers.

For community banks selling mortgages, MAX may be used alongside or as an alternative to traditional correspondent or warehouse arrangements. MAX allows sellers to test prices offered by traditional channels against the market. MAX can provide an alternative when correspondent and warehouse channels are not offering competitive prices for mortgages a seller has to offer. In effect, MAX allows an originator to take advantage of conduits offered by any or all buyers on the exchange.

Community banks may use MAX to be more competitive for their depositors' mortgage needs. With a ready, liquid market provided by MAX, community banks need not be limited by capital and risk tolerances when originating loans sought by their customers. FHLB members with mortgage banking affiliates will be able to use MAX to market loans closed by the affiliate.

Community banks, thrifts, and credit unions typically use deposits and FHLB borrowings to fund mortgage originations. This allows buyers to broadly tap originators who prefer to fund originations with deposits or FHLB advances.

Community banks also buy mortgages. That is, residential loans are desirable assets consistent with the mission of a community bank. Good quality, performing mortgages are efficient collateral for FHLB borrowing. But not all community banks and thrifts have mortgage origination capacity. “Asset poor” institutions can use MAX to assemble diversified portfolios of mortgages originated by small and large FHLB members. Thus. MAX is more efficient and sophisticated for this purpose than currently-available tools.

In alternate aspects of the present invention, global banks, investment banks, insurance companies, national mortgage conduit operators and major Wall Street firms among FHLB members may utilize MAX for alternate purposes. As buyers, members with correspondent and warehouse conduits feeding MBS issuance desks can use MAX as a distinctive means of accumulating mortgages. Superior transparency and standardization provided by MAX and the quality and stability of FHLB members as mortgage originators, make MAX valuable as a mortgage virtual conduit.

In alternate aspects of the present invention, a variety of bid and offer types are available. MAX users, for example, may post inventory at a static price or have their offer price linked to a spread based on the Fed Funds rate or their own cost of funds, allowing the offer price to change automatically based on a calculated spread.

In one aspect of the present invention, sellers may post their mortgages in a “blind” manner. Through MAX's, sellers can explore the marketplace without alerting other institutions that they are interested in liquidating a portfolio.

As will be appreciated by those skilled in the relevant art(s), approximately 80 different data points relating to the property, lender and borrower are associated with a single mortgage loan (e.g., lender's name, FHLB district, city, state, zip code, county, number of bedrooms, borrower's income, borrower's FICO score, loan-to-value ratio, etc.). Thus, in other aspects of the present invention, buyers may use commercially-available software tools that sort through hundreds of individual mortgages by identifying such data points and other factors that match specific portfolio needs and underwriting preferences. Further, large purchasers can customize their use of MAX through an Application Programming Interface (API). Such APIs would enable financial institution users to run proprietary algorithms (e.g., applications coded in C++ or Java) to sort hundreds or thousands of mortgages posted on MAX to automatically assemble customized mortgage pools with specified, desired characteristics or achieve other customized transactional behavior on the MAX.

In another aspect of the present invention, MAX can cheaply network thousands of FHLB members. Previously, however, it has been cost prohibitive for large proprietary conduits to establish relationships and transaction infrastructure with more than a relative handful of community banks, thrifts, and credit unions. And, smaller institutions were unable to provide enough volume to justify the expense of recruiting them to these conduits.

In aspects of the present invention, MAX and the FHLBs increase efficiency in secondary mortgage markets and provide an efficient, new supply of quality mortgage originations. Community banks, thrifts, and credit unions are skilled at prudent underwriting in tune with local market conditions.

Community banks typically originate mortgages as part of customer relationships, and not necessarily to generate fees. In this regard, MAX is distinct from many traditional third-party origination channels. Current experience sheds light on community bank underwriting standards. For a decade, FHLBs have been purchasing fixed-rate conforming mortgages from members to hold in their respective portfolios. In 2007, the weighted average FICO score of the combined FHLB portfolios was over 738. The combined portfolio's weighted average LTV was 71% or below. The 90+ day delinquency rate for these portfolios at year-end 2006 was 0.21%. During the first three quarters of 2007, the FHLBs purchased $4.43 billion of fixed rate conforming mortgages through current programs.

The “flight to quality” in mortgage origination and secondary markets is already favoring FHLB members. In 2007, federally chartered thrifts increased the market share of residential mortgage originations by ten percent over 2006. During Q3 of 2007, federal thrifts closed $165.1 billion of residential loans. In Q4 of 2007, residential mortgages written were $143.9 billion—a 28 percent increase over Q4 of 2006.

As will be appreciated by those skilled in the relevant art(s) after reading the description herein, the subprime collapse has left mortgage buyers unable to enforce agreements requiring originators to repurchase loans that defaulted early or were poorly underwritten. In the event that a mortgage purchased on MAX defaults early or is found to not comply with terms of the trade, FHLBs will assure that the “put back” goes according to pre-determined and agreed upon exchange rules. Roles performed by the FHLBs in MAX transactions simplify the flow of funds and allows each party assurance that the deal will close as agreed.

In an aspect of the present invention, as a prerequisite to conducting business on MAX, Introducing Members will purchase trading rights (similar to owning an NYSE seat). For example, trading rights may be priced between $500K and $1M.

In such an aspect, MAX may charges fees on each mortgage traded and for data subscriptions and other services. The total transaction fee paid by a seller and a buyer of a fixed-rate, conforming mortgage is, for example, less than $500. Introducing Members autonomously price charges for providing access to MAX for clients and for assuring settlement of client transactions.

In an aspect of the present invention, MAX governance will include Introducing Members to ensure that operations, trading practices, clearing procedures and product mix are synchronized with business objectives of users. In such aspects, committees of users and directors will take the lead in introducing new products, refining trading and clearing practices, and updating documentation and underwriting standards.

The present invention (i.e., system 100, trading flow 200, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

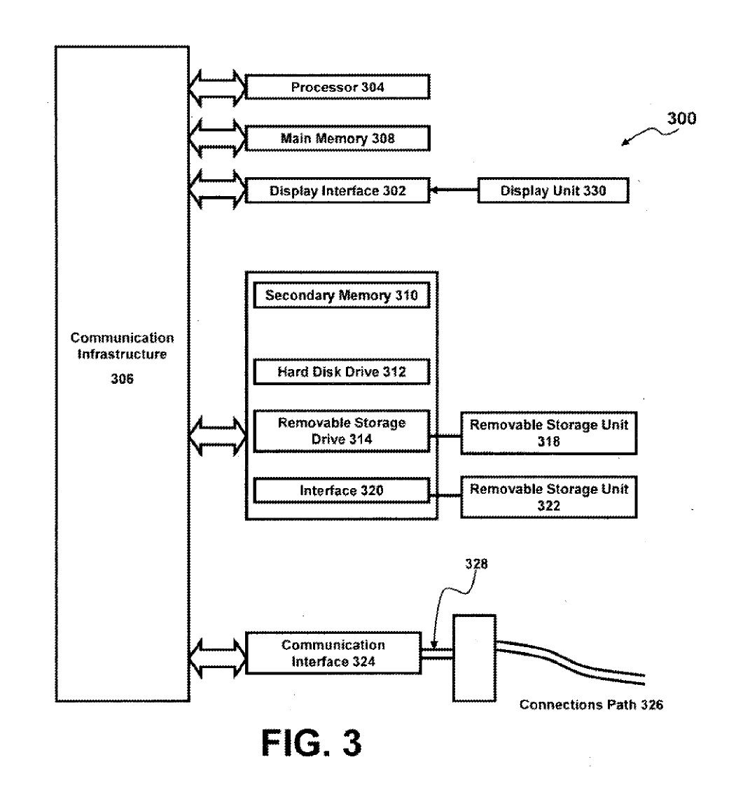

In fact, in one aspect, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on one or more display units 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative aspects, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an aspect where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

1. A secure computer system for facilitating the exchange of mortgage assets between a plurality of members, wherein a first member posts at least one bid to purchase one or more mortgage assets, a second member posts at least one offer to sell one or more mortgage assets, making available the at least one offer to sell and the at least one offer to buy to one or more of the remaining members, clearing the transaction when the system identifies agreement between the members on price, said clearing to include notification to the members, selection of a proposed settlement date depending on selected contract, and ability to oversee put-backs according to exchange rules, the system comprising:
a. a communications interface operable to send and receive mortgage data, offers to buy or sell, and responses to HTTP requests;
b. at least one processor, associated communications infrastructure operable to execute program instructions that facilitate the exchange of mortgage assets;
c. at least one first memory means operably connected to said processors;
d. at least one secondary memory means having a database for storing data relating to mortgage assets; and
e. a display interface to forward text, graphics and data from said communications infrastructure to one or more display units,
wherein the members comprise an Introducing Member, the Introducing Member being a Federal Home Loan Bank, the Federal Home Loan Bank ensuring counterparty performance, before, during, and after the transaction and overseeing standards.

2-4. (canceled)

5. The system of claim 1, wherein said at least one processor, associated communications infrastructure communications interface and first and second memory means are operable to assemble at least one pool of whole mortgage assets in response to member instructions and offer said at least one pool for sale.

6-12. (canceled)

13. The system of claim 1, wherein said at least one processor, associated communications infrastructure, communications interface and first and second memory means are operable to allow members to transfer funds among at least one of each other; and FHLB accounts.

14. The system of claim 1, wherein said at least one processor, associated communications infrastructure, communications interface and first and second memory means are operable to allow members to maintain a financial instrument that can be drawn upon to provide alternative satisfaction to a buyer whose seller failed to perform.

15-16. (canceled)

17. The system of claim 5, wherein at least one mortgage asset within said at least one pool of mortgage assets can only be sold when buyers for every whole mortgage asset within said at least one pool are identified.

18. The system of claim 1, wherein said at least one processor, associated communications infrastructure, communications interface and first and second memory means are operable to allow the posting of a bid or offer by a posting member to be invisible to some or all members based on criteria supplied by said posting member.

19. The system of claim 18, wherein an invisible bid or offer may become visible to other members when a specific event identified by said posting member occurs.

20. The system according to claim 1, wherein said at least one processor, associated communications infrastructure, communications interface and first and second memory means are operable to allow a member to be invited to view selected bids or offers based on the prior behavior or characteristics of said member.

21. The system according to claim 1, wherein said at least one processor, associated communications infrastructure, communications interface and first and second memory means are operable to allow specific quantitative characteristics or objectives to be chosen by a member to serve as a basis for one or more bids or offers.

22. The system according to claim 1, wherein said at least one processor, associated communications infrastructure, communications interface and first and second memory means are operable to allow a member to participate in the exchange anonymously for the purpose of price discovery.

23. A method for facilitating the exchange of mortgage assets between members of an exchange, comprising the steps of:
a. receiving data from the members via a communications interface, wherein said data comprises information and documents associated with at least one mortgage asset and at least one of: an offer to sell at least one mortgage asset, and offer to buy at least one mortgage asset;
b. causing said at least one offer to sell said at least one mortgage asset and said at least one offer to buy said at least one mortgage asset to be securely made available to one or more of the members;
c. storing in a memory storage medium said information and documents associated with said at least one mortgage asset;
d. using at least one computer processor to facilitate the exchange of said at least one mortgage asset between a first member and a second member, resulting in said first member selling said at least one mortgage asset to said second member;
e. using said at least one computer processor and said communications interface to notify said first member and said second member that said at least one mortgage asset has been exchanged;
f. using said at least one computer processor to retrieve said information and documents associated with said at least one mortgage asset from said memory storage medium; and
g. using said at least one computer processor, said communications interface and said memory storage medium to clear the transaction between said first member and said second member to include managing the exchange of said information and documents associated with said at least one mortgage asset, and to oversee put-backs according to the rules of the exchange,
wherein the members comprise an Introducing Member, the Introducing Member being a Federal Home Loan Bank, the Federal Home Loan Bank ensuring counterparty performance before, during, and after the exchange and overseeing standards.

24-26. (canceled)

27. The method of claim 23, wherein the step of using said at least one computer processor to facilitate the exchange of said at least one mortgage asset between said first member and said second member, further comprises generating at least one pool of mortgage assets assembled in response to member instructions and offering said at least one pool for sale.

28-31. (canceled)

32. The method of claim 23, further comprising allowing members to transfer funds among at least one of: each other; and FHLB accounts; using said at least one computer processor and said communications interface

33. The method of claim 23, wherein said data received from members via said communications interface further comprises information relating to a financial instrument that can be drawn upon to provide alternative satisfaction to a buyer whose seller failed to perform.

34-35. (canceled)

36. The method of claim 27, wherein at least one mortgage asset within said at least one pool of whole mortgage assets can only be sold when buyers for every mortgage asset within said at least one pool are identified.

37. The method of claim 23, wherein the step of using said at least one computer processor to facilitate the exchange of the said at least one mortgage asset further comprises allowing the posting of a bid or offer by a posting member to be invisible to some or all members based on criteria supplied by said posting member.

38. (canceled)

39. The method of claim 23, wherein the step of using said at least one computer processor to facilitate the exchange of said at least one mortgage asset further comprises a member to be invited to view selected bids or offers based on the prior behavior or characteristics of said member.

40. The method of claim 23, wherein the step of using said at least one computer processor to facilitate the exchange of said at least one mortgage asset further comprises allowing specific quantitative characteristics or objectives to be chosen by a member to serve as a basis for one or more bids or offers.

41. The method of claim 23, wherein the step of using said at least one computer processor to facilitate the exchange of said at least one mortgage asset further comprises allowing a member to participate in the exchange anonymously for the purpose of price discovery.

42. A computer program product comprising a computer usable medium having control logic stored therein for causing a computer to facilitate the exchange of mortgage assets between members of an exchange, said control logic comprising:
a. first computer readable program code means for causing the computer to receive data from the members, wherein said data comprises information and documents associated with at least one mortgage asset and at least one of: an offer to sell at least one mortgage asset, and an offer to buy at least one mortgage asset;
b. second computer readable program code means for causing the computer to present at least one of: said at least one offer to sell said at least one mortgage asset; and said at least one offer to buy said at least one mortgage asset, to one or more of the members:
c. third computer readable program code means for causing the computer to store said information and documents associated with said at least one mortgage asset in a memory storage medium;
d. fourth computer readable program code means for causing the computer to facilitate the exchange of said at least one mortgage asset between a first member and a second member, resulting in said first member selling said at least one mortgage asset to said second member;
e. fifth computer readable program code means for causing the computer to notify said first member and said second member that said at least one mortgage asset has been exchanged;
f. sixth computer readable program code means for causing the computer to retrieve said information and documents associated with said at least one mortgage asset from said memory storage medium; and
g. seventh computer readable program code means for causing the computer to clear the transaction between said first member and said second member by managing the exchange of said information and documents associated with said at least one mortgage asset according to a set of exchange rules,
wherein the members comprise an Introducing Member, the Introducing Member being a Federal Home Loan Bank, the Federal Home Loan Bank ensuring counterparty performance before, during, and after the exchange and overseeing standards.
